(19) United States
(12) Patent Application Publication
(10) Pub. No.: US 2007/0182579 A1
(43) Pub. Date: Aug. 9, 2007

(54) Method and apparatus for deaf and hard of hearing access to drive-through facilities

(76) Inventor: Patrick H. Hughes JR., Evanston, IL (US)

Correspondence Address: SCHIFF HARDIN, LLP;PATENT DEPARTMENT, 6600 SEARS TOWER, CHICAGO, IL, 60606-6473, US

(21) Appl. No.: 11/350,699

(22) Filed: Feb. 9, 2006

(51) Int. Cl. G09B 21/00

(52) U.S. Cl. 340/825.19

(57) ABSTRACT

A drive-through facility access kit that provides access to drive-through restaurants for customers who are deaf or hard of hearing. Apparatus is provided for installation at a drive-through facility to enable a hearing impaired person to use the drive-through service. A method is also provided for enabling access to drive-through facilities for deaf or hard of hearing customers. Apparatus, and when provided in the form of an access kit, includes an alert system located at an drive-through ordering area which can be activated by a customer. Once activated, the alert system notifies an employee of the drive-through facility that a customer will be pulling forward to the pick-up window to receive assistance in the ordering process. Inside the facility, the access kit includes a receiver which emits a signal through a speaker to a drive through attendant. The drive-through access kit may also include an induction loop telecoil system for mounting at the ordering area.

### BACKGROUND OF THE INVENTION

1. Field of the Invention

The present invention is related generally to a method and apparatus for facilitating use of drive-through facilities by persons with disabilities, and in particular to a kit, apparatus and method for improving access to drive-through restaurants or the like for customers with hearing impairment or other specific auditory disabilities.

2. Description of the Related Art

An estimated 28 million Americans are deaf or hard of hearing. Millions of Americans use assistive listening devices (also referred to as hearing aids), many of which are equipped with telecoil-based systems. Persons who are deaf or hard of hearing face particular challenges. One such challenge involves receiving service at drive-through restaurants or other drive-through facilities.

Drive-through restaurants normally include of an area at which orders are placed from a vehicle, usually by speaking toward a microphone and responding to a drive-through attendant's inquiries transmitted to the order area by an audio speaker. At the order area, a customer views the menu options and places his or her order by interacting with the attendant via the microphone and speaker. It is generally necessary that the customer confirms the spoken order by the attendant to complete the ordering process. After placing an order, the customer pulls ahead in the vehicle to a window to pick-up and pay for the ordered food.

Customers who are deaf or hard of hearing find it nearly impossible to perform these acts. Such a customer may not be able to hear or understand what the drive-through attendant is saying at the area where orders are placed. Further, in some cases, the customer cannot speak or at least is unable to speak clearly, and therefore is unable to place an order. In nearly all cases, the customer cannot hear or understand the acknowledgement of his or her order by the attendant. Customers cannot merely “pull ahead” to the pick up window as this disturbs the normal queue system and disrupts the ordering process for the restaurant. This lack of effective communication results in considerable frustration and an inability to use the drive-through facilities of restaurants by the deaf and hard of hearing community. Moreover, at many restaurants, only the drive-through facility is open at certain hours. As a result, customers who are deaf or hard of hearing may not be able to obtain service when customers without a hearing disability can receive service. This unfair discrimination violates the American with Disabilities Act, placing both the customer and restaurant in jeopardy.

Businesses miss important opportunities by unintentionally excluding disabled customers. In fact, a recent survey of over 6,500 people who are deaf or hard of hearing showed that 65% of these individuals find it difficult or impossible to use drive-through restaurants. 78% of these people have found it difficult to place a drive-through order due to communication problems; and 42% have actually left a fast food restaurant without purchasing food because they could not communicate with the restaurant staff.

The law requires businesses to make their facilities accessible to people with disabilities. Unfortunately, owners of drive-through restaurants remain unaware of what measures they can take to increase accessibility of their drive-through restaurants to deaf or hard of hearing customers. Thus, there is a need for affordable solutions to this problem.

### SUMMARY OF THE INVENTION

The present invention provides a kit for enabling restaurants or other facilities to provide access by persons who are deaf or hard of hearing to drive-through service. The kit provides a signaling apparatus for the disabled person to signal the need for assistance to an employee working at the restaurant.

The kit includes signs with which the deaf or hard of hearing person is informed about the availability of assistance. The kit also includes communication tools to allow the customer who is deaf or hard of hearing to communicate with the employee of the restaurant. Moreover, the kit consists of an induction loop system to allow communication from the restaurant's speaker system to be directly transmitted into the hearing aid of the deaf or hard of hearing customer.

In an alternative embodiment, the kit may be used to facilitate access for customers who face other communication barriers ranging from permanent or temporary inability to speak or hear foreign language barriers.

In a second alternative embodiment, the kit may be used to facilitate access for deaf or hard of hearing customers to other types of drive-through facilities, including but not limited to bank drive-through facilities, pharmacy drive-through, store drive-through facilities, and the like.

The present invention also includes a method for increasing access by persons who are deaf or hard of hearing to drive-through facilities. The method includes the steps of providing signs, alert systems and other equipment and information so that persons who are deaf or hard of hearing have increased access to drive-through facilities.

### BRIEF DESCRIPTION OF THE DRAWINGS

FIG. 1 is a schematic top isometric view of a drive-through restaurant including a drive-through restaurant access kit according to the present invention;

FIG. 2 is a perspective view of a component of an alert system of the present kit mounted onto a mounting post;

FIG. 3A is a front view of one embodiment of an alert system;

FIG. 3B is a front view of another embodiment of an alert system of the present kit including an international symbol for the deaf and hard of hearing and signage;

FIG. 4 is a front view of the signage that may be included on the alert system of the present invention;

FIG. 5 is a perspective view of a customer activating the alert system by pressing a button;

FIG. 6 is a perspective view of a receiver and employee of the drive-through restaurant hearing and responding to the alert signal;

FIG. 7 is a front elevational view of an induction loop system installed at a drive-through restaurant; and

FIG. 8 is a schematic top plan view of the drive-through restaurant access kit showing each of the component parts and indicating the position of the component parts at a drive-through restaurant.

### DETAILED DESCRIPTION OF THE PREFERRED EMBODIMENTS

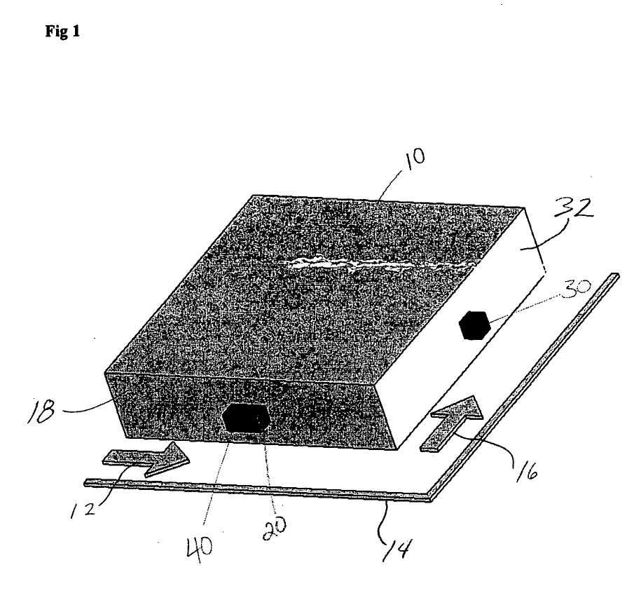

Referring first to FIG. 1, a drive-through restaurant 10 or other business having a drive-through facility is shown schematically. The drive-through restaurant 10 as shown in the Figure may be a stand alone building or may indicate only a portion of a larger building. A customer of the drive-through restaurant 10 enters the drive-through area at 12 as indicated by the arrow. The drive-through area is generally separated from parking areas by a curb 14 which prevents access to a pick up area 30 without first passing the order area, although this is not always the case. Customers using the drive-through restaurant first approach the order area 20 in their vehicle, view a menu of items available for ordering and then place an order at an ordering area 20. After placing an order, customers travel in their vehicle from the ordering area 20 to the pick-up window 30, as indicated by arrow 16. At the pick-up window 30, the customer pays for the order and receives the order that was placed by the customer at the ordering area 20. This arrangement minimizes the number of employees required to staff the drive-through facility, reducing costs for the restaurant. It also provides for greater safety for the restaurant employee such as for late night operation, since the employee never leaves the building and is behind a window under control of the employee and the customer never enters the building. This arrangement can make it difficult for deaf or hard of hearing customers, however, unless the drive-through restaurant 10 utilizes drive-through facility apparatus 40 according to the present invention. The components of the present drive-through facility apparatus is first encountered by a deaf or hard of hearing customer at the ordering area 20.

A common arrangement for drive-through restaurants, in particular, is that the order area 20 is out of sight of the pick-up window 30, as in the illustration of FIG. 1. The customer placing the order from a vehicle parked at the order area 20 cannot see or be seen by the employee at the order pick-up window 30 in the illustrated example because the order area 20 is on one side 18 of the restaurant 10 whereas the employee viewing the drive-through facility is at the pick-up window 30 on another side 2 of the restaurant building 10. If the deaf or hard of hearing customer can understand spoken language by reading lips or even if the customer uses sign language to communicate, the relative positions of the order window 20 and pick-up window 30 will prevent effective communications. In some drive-through facilities, the order area 20 is within sight of the pick-up window 30. Even then there is typically sufficient distance between the order area 20 and pick-up window 30 for one, two or more vehicles to be waiting for access to the order pick up window 30 so the distance inhibits direct visual communication. In addition to distance, visual communication may be inhibited by signs, foliage, other vehicles, or even by reflections on the vehicle window or pick-up area windows.

The method and apparatus of the present invention overcomes these and other problems by enabling a hearing impaired person to communicate to an attendant inside the restaurant that they are at the order area 20 and will need additional assistance in placing the order. The drive-through restaurant access kit 40 may be used as is or with some modification in other types of drive-through facilities. These facilities include but are not limited to drive-through bank windows, drive-through service centers, or full service gas stations.

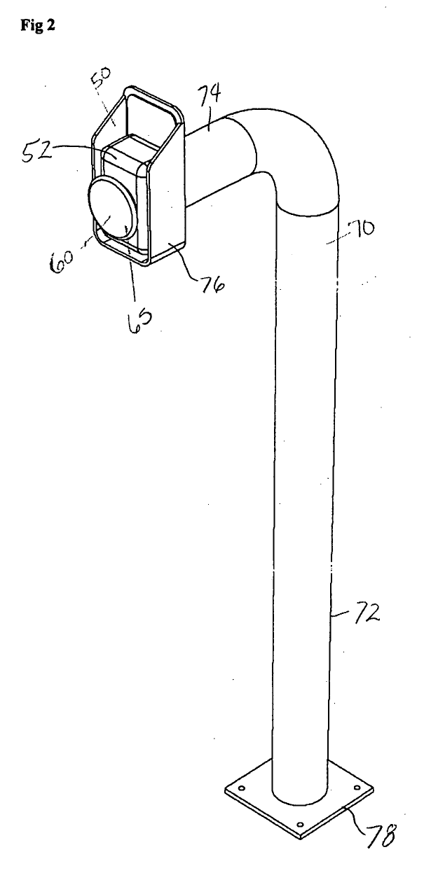

Referring to FIG. 2, the drive-through restaurant access kit 40 includes an alert system 50 located at the ordering area 20. The alert system 50 contains an alert system switch 60 which activates an alert system transmitter 52 when the switch 60 is operated. The switch 60 is marked or indicated to catch the attention of a deaf or hard of hearing customer and may be operated by pressing a pressing surface on the alert system.

In a preferred embodiment, the alert system switch 60 has a large pressing surface and requires minimal pressure to activate consistent with ADA (Americans with Disabilities Act of 1990) requirements. In one embodiment, the alert system switch 60 is round, approximately three inches (7.5 cm) in diameter. Because the alert system switch 60 will likely be mounted outside, it preferably has a cover of weather-resistant plastic 65 over at least the transmitter 52. Waterproof and weather proof seals are preferably provided. The size and format of the alert system switch 60 permits it to be activated by pressing with a finger and to be activated by a person with limited manual dexterity such as with a fist or elbow or even head, for example. The alert system switch 60 can also be activated by a cane or other implement.

The alert system 50 for some installations is mounted onto a mounting post 70. As shown in FIG. 1, the mounting post 70 has a vertical portion 72 and a horizontal portion 74 extending toward a customer's vehicle, which positions the alert system switch 60 within the reach of a customer who is deaf or hard of hearing from his or her car. The switch 60 and transmitter 52 are mounted in a protective shield 76 to block impact from a vehicle that gets too close to the alert system 50. The post 70 is mounted by a base 78 to a surface, using bolts (not shown) for example. The post 70 is of steel or other durable material in the preferred embodiments.

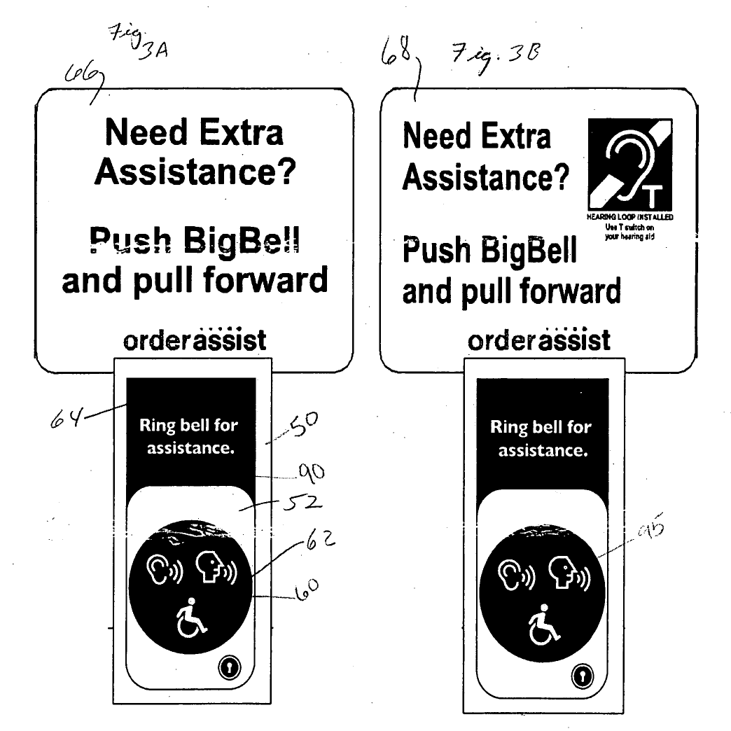

Referring to FIG. 3A, the drive-through restaurant access kit 40 also includes signage 90 attached to the alert system 50. This signage indicates to customers the existence of assistance for deaf or hard of hearing customers. The signage 90 of the preferred embodiment has several components. First, the switch 60 has a pressing surface 62 on which is marked international symbols for disabled persons, deaf persons and mute persons, secondly, a small sign 64 mounted behind the transmitter 52 instructs the customer to ring the bell for assistance. This small sign 64 should be mounted immediately adjacent the pressing surface 62 to ensure that all customers recognize that the pressing surface 62 is a switch to operate a notification system. Thirdly, the signage includes a layer, more prominent sign 66 with more specific instructions for the customer who may need assistance at the order area 20 of the drive-through facility. For example, the larger sign 66 instructs the customer to press the switch (here referred to as the Big Bell) and pull forward. The layer sign 66 may be mounted adjacent the switch 60 or apart from the switch 60. The sign 66 is large so as to be noticed by a customer approaching the order area 20 with its potentially confusing number of menu choices, prices, meal packages. The signs may indicate service for the hearing impaired by words or by using the international symbol for the deaf 95 or other signage indicating the existence of communication assistance 100. A sign mounted on an ordering menu is an alternative.

FIG. 3B shows another embodiment of signage indicating the availability of hearing loop system. The hearing loop system is an inductive coil installed at a location which transmits sounds to a hearing aid having a T-coil or telecoil apparatus. A hearing aid user is able to switch the hearing aid to the T-coil position and receive broadcasts from the telecoil apparatus using the user's existing hearing aid. With the T-coil system installed, the customer may use the drive-through just as a hearing person would. It may be necessary in some installations to push the switch to notify an employee to turn on the T-coil system.

The sign 68 shown in FIG. 3B is provided in the kit 40 for facilities having the inductive loop system while the sign shown in FIG. 3A is provided in the kit 40 for facilities that do not have the inductive coil system.

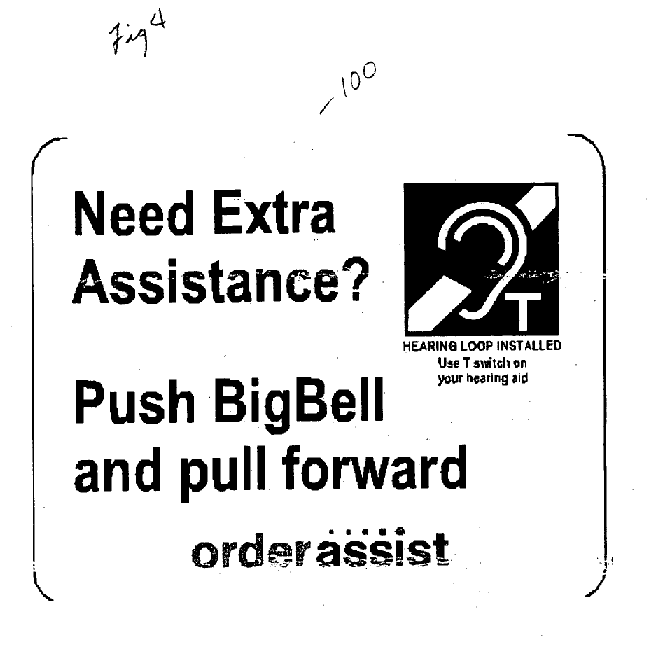

A sign 100 as shown in FIG. 4 is provided in the kit 40 of some embodiments. The sign 100 is provided for mounting at a location separate from the post 70, such as on or near the menu or other convenient and noticeable location. The sign 100 is similar in appearance to the sign 68 of FIG. 3B to aid the customer in finding the location of the bell switch. For customers without a T-coil receiver in their hearing aid, the signs indicate “ring bell and pull ahead.” The employee in the restaurant then knows to expect a hearing impaired customer at the pick-up window. The signage 100 may also indicate the existence of an induction loop system.

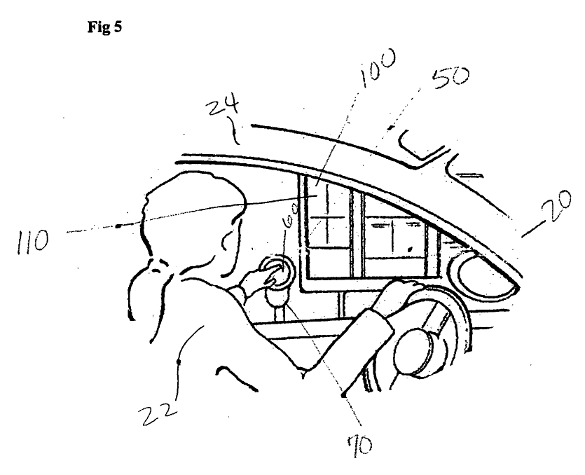

Referring to FIG. 5, a customer 22 first encounters the alert system 50 mounted to the mounting post 70 upon arriving at the ordering area 20 in a vehicle 24. At an ordering menu board 110, is posted signage 100 indicating how deaf or hard of hearing should request assistance by operating the alert system switch 60. The customer 22 will push the alert system switch 60 which will ring an alert and/or flash a light inside of the restaurant 10.

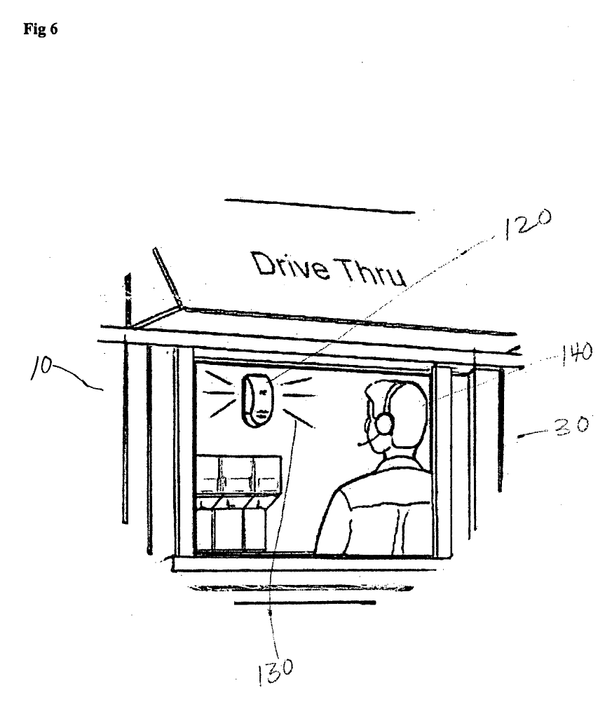

Referring to FIG. 6, a receiver 120 is located inside the restaurant 10, such as near the pick-up window 30. When the customer 22 at the ordering area 20 pushes the alert system switch 60, the receiver 120 receives the signal wirelessly or wired from the alert system 50 and produces an alert signal 130 in the form of either sound or flashing of a light or both, inside of the drive-through restaurant 10. An employee 140 of the drive-through restaurant receives the alert 130. As a result, the employee is made aware that the customer at the ordering area 20 needs additional assistance in the ordering process when the customer pulls forward to the pick-up window 30 where the employee 140 is located. Once at the pick-up window 30, the customer 22 is better able to communicate to the employee 140, such as by reading lips, sign language, written communication, picture menus, body language or otherwise. The employee may be trained to communicate with hearing impaired people. Training material may be provided in the kit 40.

This system thus allows any customer with a communication barrier to alert or prepare the staff that they will be pulling forward to place an order and allows the staff to enter the customer into the queue system. At the pick-up window 30, the customer is able to place an order by using any known communication device that allows a deaf or hard of hearing customer to place an order. These communication devices include but are not limited to pen and paper, or a written menu that the customer can point to so as to indicate an order.

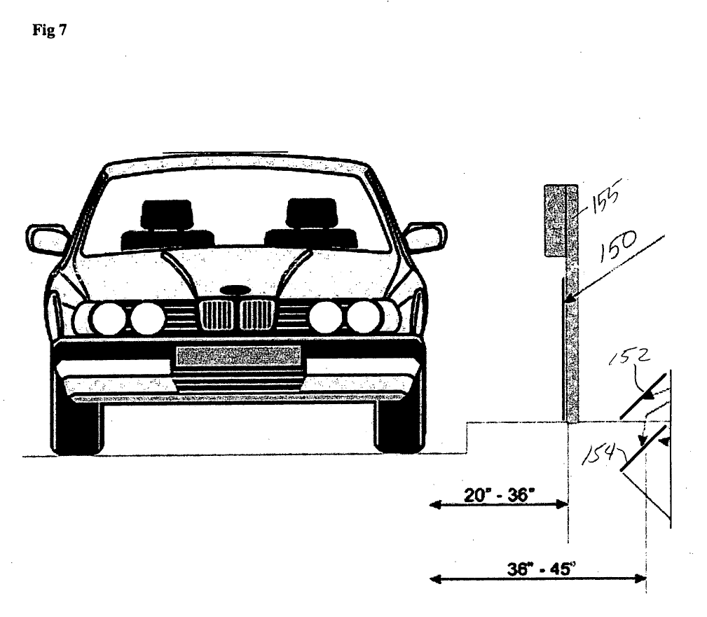

In an alternative embodiment, the drive-through restaurant access kit 40 also includes or has information on obtaining an induction loop telecoil system 150 indicated in FIG. 7. The induction loop telecoil system 150 is located in or near a speaker box 155 at the ordering area 20. In an alternative embodiment, an induction loop telecoil system may also be placed at the pick-up window 30 and/or at the service counter inside the restaurant 10. The induction loop telecoil system 150 which may include coils 150, 152 and/or 154 allows customers who are deaf or hard of hearing, and who have hearing aids equipped with a telecoil to hear transmitted communication. At drive-through restaurants, the induction loop telecoil system 150 will transmit the signal that is supplied to the speaker box 155 directly into the customer's hearing aid, allowing the customer to use the drive-through restaurant like any other customer.

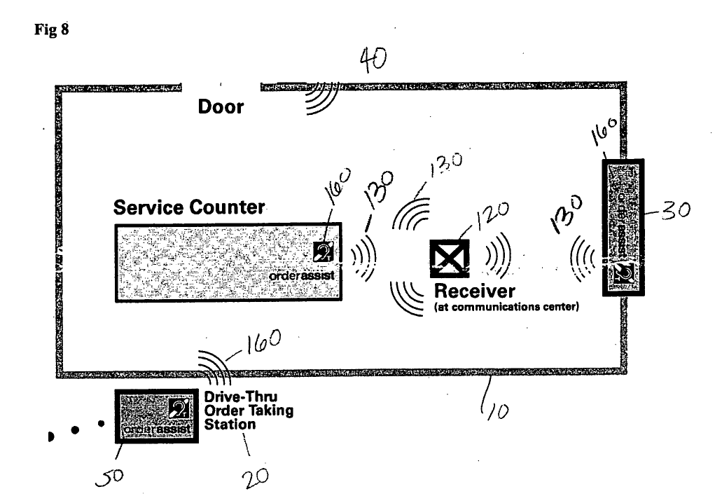

FIG. 8 shows the component parts of the drive-through restaurant access kit 40 and their respective locations at a drive-through restaurant 10. At the ordering area 20, a deaf or hard of hearing customer activates the alert system switch 60. The alert system switch 60 activates the power supply such as a battery or AC power and a radio transmitter. The radio transmitter preferably operates on an industry-standard frequency which is picked up by the receiver 120 inside the restaurant 10. The speaker 120 may be plugged into a standard AC wall socket. The transmitter of a preferred embodiment has a range of up to 500 feet. The embodiment of the alert system switch 60 powered by a batatery is therefore a self-contained unit which does not require external wiring, and is easy to install.

In one embodiment, the operation of the alert system 50 causes an alert 130, in the form of an audible signal, to be emitted from a speaker 160 mounted inside the drive-through restaurant 10. The speaker 160 is preferably mounted near an employee station of the drive-through restaurant, such as near the counter at which the drive-through attendant stands. The alert system switch 60 and speaker 160 are linked to one another by radio signals. The alert system switch 60 is provided with a short range radio transmitter, and the speaker 160 is provided with a corresponding receiver 120. The alert system switch 60 of one embodiment is powered by batteries, and the receiver 120 of that embodiment is plugged into a standard AC wall socket within the drive-through restaurant. A battery-operated receiver is an alternative embodiment.

Therefore, when an employee of a drive-through restaurant receives the alert 130, he or she knows that a deaf or hard of hearing customer will be pulling forward to the pick-up window 30 in order place an order with additional assistance. Combined, this system offers an accessibility solution for drive-through restaurants to deaf or hard of hearing customers. This system works regardless of whether the deaf or hard of hearing customer uses a telecoil-equipped hearing aid. However, for those customers who do use a telecoil-equipped hearing aid, a telecoil system is offered to allow such customers to hear the ordering system. For those deaf or hard of hearing customers without hearing aids, the system nevertheless allows them to push a button, request assistance, and pull forward to complete their order in a dignified manner.

The present invention also provides a bit of the assembled materials for installation at a restaurant or other drive-through facility. The kit enables an owner or manager of a business having a drive-through facility to purchase and install the kit and thereby remove barriers to use of the drive-through facility by the hearing impaired. The kit includes the components necessary for easy use of the drive-through facility by hearing impaired persons, including the button and transmitter assembly, signs instructing hearing impaired persons on the use of the system, and a receiver for mounting inside the facility to alert employees or attendants to the activation of the transmitter.

In most versions of the kit, a post for mounting the button and transmitter at an order area of the drive-through facility is also provided. The kit may also include multiple signs for mounting at several locations in the vicinity of the drive-through facility. For some installations, multiple receivers and/or transmitters may be used. The kit may include such multiple components. The kits may be provided in different versions depending on the needs of the drive-through facility, or alternately a basic kit is provided with the components most commonly used at a drive-through facility and an order form is provided for the facility to order needed additional components and materials. The kit may be provided in a box or other container or may be provided in several containers. The kit includes instructions for installation and use of the components and preferably has information on the issues faced by the hearing impaired and ways to facilitate communications between attendants and hearing impaired customers.

The present invention provides a method for making a drive-through facility accessible to the hearing impaired. The present invention also provides a method for providing a kit for retrofitting/converting a drive-through facility to one more easily used by a person with a hearing impairment. The details of the methods are apparent from a review of the foregoing description.

Although other modifications and changes may be suggested by those skilled in the art, it is the intention of the inventors to embody within the patent warranted hereon all changes and modifications as reasonably and properly come within the scope of their contribution to the art.

I claim:

1. Apparatus for access by hearing impaired persons to a drive-through facility, comprising:
an alert device mounted at a position within reach of a person using the drive-through facility, said alert device being selectively activated by a user of the drive-through facility, said alert device being operable to initiate an alert signal;
a signal device inside the drive-through facility, said signal device being in communication with said alert device and being operable to emit a signal to an attendant upon receipt of said alert signal;
signage mounted near said alert device including indicia indicating to a user of the drive-through facility to activate said alert device.

2. Apparatus as claimed in claim 1, further comprising:
a mounting post on which said alert device is mounted, said mounting post including a mounting portion constructed for mounting within reach of the person using the drive-through facility.

3. Apparatus as claimed in claim 1, further comprising:
signage including indicia indicating to a user the presence of a telecoil system at the drive-through facility.

4. Apparatus as claimed in claim 1, wherein said alert device includes a radio transmitter in a housing and a button on said housing connected to activate said radio transmitter upon pressing said button, said radio transmitter being operable to emit a radio signal;
said signal device including a radio receiver and an audio alert apparatus, said radio receiver being connected to said audio alert apparatus to emit an audio alert upon receipt of said radio signal from said radio transmitter.

5. Apparatus as claimed in claim 1, wherein the drive-through facility includes an order area and a pick up area, said alert device being mounted at said order area, said signage being mounted at said order area, and said signal device being mounted at said pickup area.

6. Apparatus as claimed in claim 5, wherein said apparatus includes indicia instructing a user to operate the alert device and to move to the pickup area.

7. A method for enabling use of a drive-through facility by a hearing impaired person, comprising the steps of:
providing an alert device for mounting at a drive-through order area;
providing signage for mounting at the drive-through order area; and
providing a signal device for mounting inside the drive-through facility.

8. A method as claimed in claim 7, further comprising the step of:
providing a mounting post for holding said alert device in a position accessible by a person in a vehicle at the drive-through area.

9. A method for enabling a hearing impaired person to utilize a drive-through facility, comprising the steps of:
providing an alert device at a position in a drive-through order area of the drive-through facility for access by a person in a vehicle in the drive-through area;
marking the alert device with international symbols for hearing impaired use;
providing instructions via signage at the drive-through order area on use of the alert device by a hearing impaired person; and
alerting an attendant to operation of the alert device by a hearing impaired person.

10. A method as claimed in claim 9, further comprising the step of:
providing a telecoil apparatus at the drive-through order area;
indicating to a hearing impaired user at the drive-through order area that a telecoil apparatus is present; and
communicating with the hearing impaired user via the telecoil apparatus.

11. A drive-through restaurant access kit, comprising:
an alert system to be mounted at an order taking area of a drive-through restaurant;
signage indicating accessibility for customers who are deaf or hard of hearing persons to be mounted near to said alert system;
a mounting post to which said alert system is attached so that said alert system can be reached by deaf or hard of hearing persons from a vehicle;
signage indicating availability of accessibility services for customers who are deaf or hard of hearing to be attached to said mounting post;
a receiver in communication with said alert system and operable to alert an attendant of the drive-through restaurant to presence of the customer who is deaf or hard of hearing will need additional assistance to make a selection of items from the restaurant.

12. A drive-through restaurant access kit as claimed in claim 11, further comprising:
an induction loop telecoil system mounted to communicate with a hearing aid wearer have a hearing aid equipped with a telecoil at the order area; and
signage including indicia to instruct hearing impaired customers in use of the drive-through restaurant.

13. A drive-through restaurant access kit as claimed in clam 11, wherein the alert system is marked with an international symbol for deaf and hard of hearing.

14. A drive-through restaurant access kit as claimed in claim 11, wherein said alert system is operable by pressing an alert system switch.

15. A drive-through restaurant access kit as claimed in claim 1, wherein said alert system includes a radio transmitter and is operable to emit a radio signal; and wherein said a receiver is a radio receiver operable to receive the radio signal from said alert system and generate an alert upon receipt of the radio signal.

16. A method for providing access to drive-through restaurants for deaf or hard of hearing persons, comprising the following steps:
providing the drive-through restaurant access kit including:
an alert system,
signage,
a mounting post, and
a receiver; and
instructing drive-through restaurant employees on use of the drive-through restaurant access kit.
